(19) United States
(12) Patent Application Publication
(10) Pub. No.: US 2025/0042764 A1
(43) Pub. Date: Feb. 6, 2025

(54) PROCESS FOR THE REFINING OF IRON OXIDES, IRON OXIDES RESULTING THEREOF AND THEIR USE

(71) Applicant: BASF SE, Ludwigshafen am Rhein (DE)

(72) Inventors: Florina Corina PATCAS, Ludwigshafen am Rhein (DE); Timo HENSLER, Ludwigshafen am Rhein (DE); Matthias Wilhelm MEIER, Ludwigshafen am Rhein (DE)

(21) Appl. No.: 18/716,593

(22) PCT Filed: Dec. 9, 2022
(86) PCT No.: PCT/EP2022/085142

§ 371 Date: Jun. 5, 2024

(30) Foreign Application Priority Data
Dec. 10, 2021 (EP) 21213619.6

(51) Int. Cl. C01G 49/06

(52) U.S. Cl. CPC C01G 49/06; C01P 2006/12

(57) ABSTRACT

The present invention relates to a method for the refining of a material comprising iron oxide and at least one contaminant selected from the group consisting of halogen and sulfur by reducing the content of the at least one contaminant, characterized by calcining the material in the presence of a gas containing water vapor. The invention also relates to a refined material obtainable from such a method and the use for catalyst production.

The present invention relates to a method for the refining of a material comprising iron oxide and at least one contaminant selected from the group consisting of halogen and sulfur by reducing the content of the at least one contaminant, characterized by calcining the material in the presence of a gas containing water vapor. The invention also relates to a refined material obtainable from such a method and the use in catalyst production.

Iron oxides are used in a multitude of industrial applications. In some of them, like the manufacturing of catalysts, batteries and electrotechnical components, the requirements concerning the purity are quite restrictive. For instance, the presence of halogens or sulfur may induce damages in the material performance or corrosion for the casing and downstream section of the catalytic reactors.

The manufacturing routes used industrially for iron oxides, while being optimized for low costs and high efficiency, induce the presence of such impurities like halogens or sulfur by the very nature of the process. For instance, reducing the chloride content in regenerated iron oxides from steel-pickling acid waste by the Ruthner process is one of the critical issues for the development of regenerated iron oxides as a useful raw material resource. By this route, iron chloride solutions resulting from the cleaning of steel sheets with hydrochloric acid are spray roasted in the presence of air. The resulting iron oxides contain chlorine as impurity.

In the Penniman processes, iron oxides are manufactured from iron sulfate solutions. The resulting iron oxides are contaminated with sulfur.

The patent literature reflects the many efforts carried out in the past by different catalyst manufacturers to eliminate such contaminants from the iron oxide raw materials.

For instance, in WO 95/25069 A1, iron oxide containing chlorine from the regeneration of steel pickling liquor was treated with sulfuric acid solutions, then filtered, dried and optionally calcined to reduce the chlorine content. The disadvantages of this method are obviously the consumption of chemicals (H₂SO₄) and the waste solution resulted.

In EP 1 178 012 B1, iron oxide containing chlorine was treated with diluted solutions of nitric acid (HNO₃), then filtered, dried and calcined to obtain oxide with reduced chlorine content. As in the previous literature citation, here as well the consumption of chemicals and the resulted waste acid solution are disadvantageous for the process costs and environmental footprint.

In EP 1 379 470 B1, iron oxide is treated in dry air at a higher temperature without addition of any chemicals in order to reduce the chlorine content. Considering that no chemicals and wastewater are issued, this process is economically and environmentally more advantageous than the previously cited. However, the iron oxide must be calcined at quite high temperatures in the range of up to 1150° C. in order to achieve low residual chlorine contents. As a result, the specific surface area of the treated material becomes quite low, which reduces the reactivity of the iron oxide and constitutes a drawback for its use as a catalyst precursor. Additionally, the calciner tube must be equipped with tappers or hammers to prevent the sticking of the iron oxide powder to the tube wall.

GB 1 203 967 A teaches the calcination of an iron oxide in the presence of a gas containing a hydrohalic component, like hydrogen chloride, and water vapor, with the aim of removing non-ferrous metal impurities from the iron oxide by means of transforming them into volatile non-ferrous metal chlorides. The role of water in this reaction system is to prevent iron oxide to volatilize itself as a chloride. There is no information in this document about the possible contamination of the resulted iron oxide by halogen, as its focus is on metallic impurities; on the contrary, halogen is introduced in the reaction system on purpose, in order to achieve the target of reducing the content of metallic impurities.

Thus, there is still a need of optimized methods for refining iron oxide in order to reduce contaminant amounts in form of halogens or sulfur, such that the calcination temperature needed and/or the loss of specific surface area is lower.

Accordingly, an object of the present invention is the provision of such a process and iron oxide resulting thereof.

This object is achieved by a method for the refining of a material comprising iron oxide and at least one contaminant selected from the group consisting of halogen and sulfur by reducing the content of the at least one contaminant, characterized by calcining the material in the presence of a gas containing water vapor.

Surprisingly, it was found that by calcining iron oxide in the presence of a gas containing water vapor, like moist air, the content of halogen and sulfur contaminants can be reduced more drastically and the loss of specific surface area is diminished in comparison to the calcination in dry gas, like dry air.

Furthermore, it was found that by calcination of the iron oxide material in a calciner tube lined with a ceramic material, the adhesion of the iron oxides to the calciner tube can be avoided and by this there is no need for using tapping devices, as necessary when calcining in bare metallic calciner tubes.

The present invention can be used for the purification of any kind of iron oxide material containing halogen or sulfur, irrespective of its origin, mineral or synthetic. For instance, the iron oxide may be of Ruthner or regeneration type, Pennimann, precipitation from sulfate salts etc.

Preferably, the material used in the method for the refining is produced by spray roasting hydrochloride acid waste liquids generated from steel pickling or by a Penniman process. Preferably, the iron oxide submitted to purification as well as the purified product consist essentially of hematite (Fe₂O₃) phase. The term “essentially consists of” preferably refers to a content of the hematite phase of at least 90%, more preferably of at least 95%, even more preferably of at least 99%, even more preferably of at least 99.9%. The material used in the method of the present invention is subject to calcination in form of a powder.

The content of halogen or sulfur impurity in the initial material can amount to up to several weight percent (several tens of thousands of ppm, understood as parts per million by weight). Accordingly, the material used in the method of the present invention preferably comprises iron oxide in the amount of at least 90 percent by weight (wt-%) based on the total amount of the material. However, typically the material used for the refining method of the present invention comprises at least 95 wt.-%, even more preferably, at least 97 wt.-%, even more preferably, at least 99 wt.-%. Thus, in a preferred embodiment the material used for the refining method of the present invention is iron oxide having up to 10 wt.-% impurities, more preferably, up to 5 wt.-%, more preferably, up to 3 wt.-%, more preferably, up to 1 wt.-% (=10,000 ppm).

The material used in the method for the refining of the present invention comprises iron oxide and at least one contaminant selected from the group consisting of halogen and sulfur.

Thus, at least one impurity contained in the iron oxide is halogen, preferably chorine, or sulfur. Thus, in a preferred embodiment of the present invention the material comprises chlorine as halogen contaminant, preferably in the amount of at least 800 ppm (parts per million by weight calculated as CI, in case the halogen is chlorine). Typically the amount ranges from 800 ppm to 5000 ppm. The halogen is typically present in the material as halogenide, chloride accordingly (for halogen=chlorine). Thus, in another preferred embodiment of the present invention the material comprises sulfur as contaminant, preferably in the amount of at least 800 ppm (parts per million by weight calculated as S). Typically the amount ranges from 800 ppm to 5000 ppm. The sulfur is typically present in the material as sulfate, sulfite or sulfide. In a further embodiment of the present invention, the iron oxide contains at least both mandatory impurities, i.e. halogen and sulfur.

After the treatment, the residual content of halogen or sulfur may amount up to several thousands of ppm, preferably up to several hundreds of ppm, most preferably down to several tens of ppm or even below 10 ppm. Thus, the residual content is preferably below 100 ppm. Preferably, the content of the at least one contaminant is reduced by at least 85%, more preferably by at least 90%.

In a preferred embodiment, the material comprising iron oxide and impurities is calcined in an apparatus for calcination, like a stationary kiln, a roller hearth kiln, pusher slab kiln, a rotary oven, a fluidized bed or in a flash calciner. The equipment of the apparatus for calcination is designed to allow calcination of the material in the presence of a gas containing water vapor. For example, the equipment includes a fan in order to provide a steady flow of the gas. The gas is preferably air, nitrogen, combustion gas or a mixture thereof, preferably a mixture containing air, especially air. Air containing water vapor is also mentioned herein as moist air. To introduce water vapor in the air stream, different methods may be devised. For instance, low pressure steam may be introduced directly in the inlet air pipe of the calciner. Or, water can be metered by a dosing pump and injected into the stream of gas, preferably via a nozzle as a spray or in the form of droplets, at the inlet of the calciner. Or, the air can be passed through a saturator column filled with a contact material to increase the surface area, where water is introduced by a corresponding pump. To facilitate the evaporation, the column may be heated. The described means to introduce the water vapor into the gas stream can also be applied by introducing the vapor or spray directly into the oven chamber.

The term “air” means a mixture of nitrogen and oxygen in any ratio as main components, especially with a content of at least 95 Vol.-%, typically of at least 99 Vol.-% under standard conditions based on the total amount of gases and with a preferred content of N₂ of 78 Vol.-% and O₂ of 21 Vol.-% (“natural” content).

Preferably, the gas containing water vapor, like moist air, contains at least 0.5 Vol-% of water vapor based on the total volume of the gas. The content can be up to 100 Vol.-%, i.e. the gaseous phase consists of water vapor only. Typically, the content ranges from 1 Vol.-% to 50 Vol.-% water vapor, preferably from 1.5 Vol.-% to 40 Vol.-%, more preferably from 2.0 Vol.-% to 30 Vol.-%, even more preferably from 2.5 Vol.-% to 20 Vol.-%, even more preferably, from 2.5 Vol.-% to 15 Vol.-% water vapor. The gas with a given content of water vapor can be prepared by mixing the dry gas with the calculated amount of pure water vapor.

The gas is typically free of halogen, especially free of chorine.

The ratio of gas to material used in the method for the refining of the present invention is preferably in the range of from 0.01 Nm³ gas per kg material (Nm³/kg) to 100 Nm³/kg, more preferably in the range of from 0.1 to 10 Nm³/kg and even more preferably in the range from 0.1 Nm³/kg to 5 Nm³/kg. The gas can be fed in co-current mode or in counter-current relative to the displacement of the solid material.

The calcination temperature used is preferably from 700° C. to 1200° C., more preferably from 800° C. to 1150° C., even more preferably from 850° C. to 1120° C., even more preferably from 850° C. to 1000° C. The calcination time can vary and takes from 0.1 seconds to 24 hours. A typical calcination time is from 5 minutes to 120 minutes, like 30 to 60 minutes. This time is used to treat the material with a constant temperature. In order to reach this temperature a phase of heating up from room temperature is required. The heating rate can vary in the range between 1 K/min and 5000 K/sec. A typical heating gradient is from 1 K/min to 50 K/min, preferably from 5 K/min to 40 K/min, more preferably from 10 K/min to 30 K/min, like 20 K/min.

5 The apparatus for calcination may be heated electrically through its wall, or by microwave heating, or by burning fuel gases either indirectly (without direct contact of gases with the solid iron oxide) or directly by contacting hot combustion gases with the iron oxide. In the last case, part or all of the moisture needed in order to perform the process after the invention is supplied by the burning process. For instance, when using methane as a fuel the exemplary reaction is:

CH₄+2O₂═CO₂+2H₂O

Besides the above named example of methane, also other materials can serve as fuel for combustion, for example gaseous or liquid hydrocarbons or hydrogen.

Accordingly, the gas containing water vapor can be a mixture of air and fuel, wherein the mixture has preferably an air-fuel equivalence ratio of above 1.0; more preferably in the range from 1.1 to 30, more preferably from 1.2 to 5.0.

The apparatus for calcination may be in form of a rotating kiln, confectioned of high-temperature steel, and coated or lined with a ceramic material. It has been surprisingly found, that by using a ceramic coating, the rotary kiln can be used for the calcination of iron oxide without any device for detaching the iron oxide powder from the calciner tube. The ceramic coat May consist of different refractory materials, like alumina, alumino-silica, zirconia, magnesium aluminate, silicon carbide and the likes. The tube may also be used without such a lining. In this case, it was observed that the iron oxide powder sticks to the tube, and a tapping device must be used to perform regularly the detachment of the iron oxide cake from the tube wall.

Thus, in a preferred embodiment, the method of the present invention is carried out in a rotating kiln, preferably having an inner ceramic coating.

The rotating kiln may be operated at a slope of 0.3 to 5°, preferably from 0.4 to 3° related to the horizontal. The rotation speed of the kiln tube may range from 0.4 to 8 rpm (rotations per minute), preferably from 0.5 to 5 rpm.

The calcination may be performed at atmospheric pressure, or a slightly sub-atmospheric pressure (suction of the off-gas with a ventilator), or a slightly over-atmospheric pressure like forcing moist air with the help of a compressor through or over the solid material.

The method of the present invention is preferably carried out without a preceding treatment with an acid or base. Especially, acid treatment is described in WO 95/25069 A1 and EP 1 178 012 B1.

The specific surface area according to the BET method (DIN ISO 9277:2014-01) of the material used in the method for refining according to the present invention is typically from 1 m²/g to 10 m²/g, preferably from 3 to 5 m²/g. The resulting material after the calcination with the reduced content of contaminants (refined material) has preferably a specific surface area BET of at least 1 m²/g.

Thus, another aspect of the present invention is a refined material obtainable by a method for refining of the present invention.

Iron oxides with reduced contaminant content according to the invention generally have a residual chloride content of less than 400 ppm, preferably less than 300 ppm and particularly preferably less than 250 ppm, especially less than 200 ppm. The average particle size, determined by laser diffraction, is generally more than 0.5 μm, i.e., from 1 μm to 200 μm, preferably from 1.5 μm to 100 μm, particularly preferably from 2 μm to 80 μm and very particularly preferably from 2 μm to 30 μm, and the fines fraction having particle sizes of less than 1 μm is generally less than 15% by weight, preferably less than 10% by weight, particularly preferably less than 5% by weight. The BET surface area of the iron oxides treated according to the invention is generally in the range from 0.4 to 5 m²/g, preferably in the range from 0.4 to 3.5 m²/g, particularly preferably in the range from 0.5 to 3 m²/g and especially in the range from 0.6 to 2.5 m²/g, very particularly preferably in the range from 0.7 to 2 m²/g. Preferably, the BET specific surface is at least 1 m²/g. The iron oxides treated according to the invention generally have a hematite structure. They are useful for a whole series of industrial applications such as pharmaceuticals, cosmetics, magnetic tape coatings, battery materials, chemical reactions, catalysts or for preparing catalysts, especially for preparing catalysts for dehydrogenation of ethylbenzene to styrene.

Accordingly, the refined material obtainable by the process of the present invention is useful as part of a catalyst. Thus, another aspect of the present invention is a catalyst containing said material. Such a catalyst can be used in a process for styrene production.

The industrial production of styrene by dehydrogenation of ethylbenzene can be effected by isothermal processes or by adiabatic processes. The isothermal process is generally operated at from 450° C. to 700° C., preferably from 520° C. to 650° C., in the gas phase with addition of water vapor at pressures from 0.1 bar to 5 bar, preferably from 0.2 bar to 2 bar, particularly preferably from 0.25 bar to 1 bar, especially from 0.3 bar to 0.9 bar. The adiabatic process is generally operated at from 450° C. to 700° C., preferably from 520° C. to 650° C., in the gas phase with addition of water vapor at pressures from 0.1 bar to 2 bar, preferably from 0.2 bar to 1 bar, particularly preferably from 0.25 bar to 0.9 bar, especially from 0.3 bar to 0.8 bar. Catalysts for the dehydrogenation of ethylbenzene to styrene can be regenerated by means of water vapor.

Catalysts for the dehydrogenation of ethylbenzene to styrene generally contain iron oxide and an alkali metal compound, for example potassium oxide. Such catalysts generally further contain a number of promoters. Promoters described include for example compounds of calcium, magnesium, cerium, molybdenum, tungsten, chromium and titanium. The catalysts may be prepared using compounds of the promoters that will be present in the ready-produced catalyst or compounds which during the production process convert into compounds that are present in the ready-produced catalyst. The catalysts used may also include assistants to improve the processibility, the mechanical strength or the pore structure. Examples of such assistants include potato starch, cellulose, stearic acid, graphite or Portland cement. The materials used can be mixed directly in a mixer, kneader or preferably a muller. They can also be slurried up into a sprayable mix and be spray dried to form a powder.

### EXAMPLES

The following exemplary embodiments illustrate the difference made by using moist air in comparison with a treatment using a dry air atmosphere.

### Example 1 (Comparative)

As a starting material a raw iron oxide was used containing 935 ppm chlorine and having a surface area of 4.15 m²/g. A quantity of 500 g of oxide powder was placed in a rotary quartz glass calciner. The calciner was fed with dry air at a rate of 470 Nl/h. The calciner was heated from room temperature up to the target temperature for calcination at a rate of 20 K/min. After the heating phase, the target temperature was kept constant for a dwell time of 30 min. Subsequently the reactor was cooled down to room temperature. The initial cooling rate immediately after completing the dwell time was approx. 15 K/min. After cooling down, a sample of treated oxide was collected and analyzed yielding the characteristics shown in Table 1.

### Example 2 (Embodiment of Invention)

As starting material the same raw iron oxide, the same setup and heating temperature were used as in the Comparative example 1 with the sole difference that the air fed contained water vapor in an amount of 1.5 Vol.-%. The water vapor concentration was adjusted by sending a stream of dry air to an evaporation unit, which is fed with water at a defined flow rate by means of a high-precision pump. To avoid condensation effects and concomitant alteration of the moisture content in the gas stream, the pipe system between the evaporation unit and the calciner is heated externally at a temperature of 180° C. The analytical data of the treated oxide are shown in Table 1.

### Example 3 (Embodiment of Invention)

As starting material the same raw iron oxide, the same setup and heating temperature were used as in the Comparative example 1 with the sole difference that the air fed contained water vapor in amount of 2.5 Vol.-%. The analytical data of the treated oxide are shown in Table 1.

### Example 4 (Embodiment of Invention)

As starting material the same raw iron oxide, the same setup and heating temperature were used as in the Comparative example 1 except that the air fed contained water vapor in amount of 5 Vol.-%. The analytical data of the treated oxide are shown in Table 1.

### Example 5 (Embodiment of Invention)

As starting material the same raw iron oxide, the same setup and heating temperature were used as in the Comparative example 1 except that the air fed contained water vapor in amount of 10 Vol.-%. The analytical data of the treated oxide are shown in Table 1.

### Example 6 (Embodiment of Invention)

As starting material the same raw iron oxide, the same setup and heating temperature were used as in the Comparative example 1 except that the air fed contained water vapor in amount of 15 Vol.-%. The analytical data of the treated oxide are shown in Table 1.

### Example 7 (Embodiment of Invention)

As starting material the same raw iron oxide, the same setup and heating temperature were used as in the Comparative example 1 except that the air fed contained water vapor in amount of 30 Vol.-%. The analytical data of the treated oxide are shown in Table 1.

### Example 8 (Comparative)

The same raw iron oxide, the same setup and dry air were used as in the Comparative example 1, except that the heating temperature was 850° C. The analytical data of the treated oxide are shown in Table 1.

### Example 9 (Embodiment of Invention)

The same raw iron oxide, the same setup and heating temperature were used as in the Comparative example 8 except that the air fed contained water vapor in amount of 2.5 Vol.-%. The analytical data of the treated oxide are shown in Table 1.

### Example 10 (Comparative)

The same raw iron oxide, the same setup and dry air were used as in the Comparative example 1, except that the heating temperature was 975° C. The analytical data of the treated oxide are shown in Table 1.

### Example 11 (Embodiment of Invention)

The same raw iron oxide, the same setup and heating temperature were used as in the Comparative example 10 except that the air fed contained water vapor in amount of 2.5 Vol.-%. The analytical data of the treated oxide are shown in Table 1.

### Example 12 (Comparative)

As a starting material a raw iron oxide containing 2200 ppm sulfur and having a surface area of 7.4 m²/g was used. Calcination conditions were identical with those of Comparative Example 1 and dry air was used. The analytical results are shown in Table 2.

### Example 13 (Embodiment of Invention)

The same raw iron oxide, the same setup and heating temperature were used as in the Comparative example 12 except that the air fed contained water vapor in amount of 10 Vol.-%. The analytical data of the treated oxide are shown in Table 2.

### Example 14 (Embodiment of Invention)

An iron oxide containing 1000+/−200 ppm chlorine and having a surface area of 4.0+/−0.5 m²/g was used. The calcination was carried out in a directly fired rotary calciner. The feeding rate of the powder material was 45.5 kg/h; the feeding rate of air was 86 Nm³/h and of the methane fuel gas was 7.1 Nm³/h yielding an air-fuel equivalence ratio of 1.3 at the burner and a theoretical water content of 15 Vol.-% in the burner off-gas. The burner off-gas was contacted directly with the iron oxide powder. Rotation rate of the calciner was 4 rpm. The temperature of the material inside the calciner was 1085° C. (pyrometer reading). Under these conditions a treated iron oxide was obtained containing 10 ppm chlorine and having a BET surface area of 1.1 m²/g.

### Example 15 (Embodiment of Invention)

The same iron oxide and same calciner and calcination conditions were used as in Example 14, except that the feeding rate of air was 100 Nm³/h and of the methane fuel gas was 7.6 Nm³/h yielding an air-fuel equivalence ratio of 1.4 at the burner and a calcination temperature (pyrometer reading) of 1120° C. and a theoretical water content of 14 Vol.-% in the burner off-gas. Under these conditions a treated iron oxide was obtained containing 7 ppm chlorine and having a surface area of 0.8 m²/g.

TABLE 1

| | H₂O content in | Chlorine | |
|---|---|---|---|
| | calcination air, | content, | BET surface |
| | Vol. % | ppm | area, m²/g |
| Raw, un-treated iron oxide | — | 935 | 4.15 |
| T = 930° C. | | | |
| Comp. Ex. 1 | 0 | 147 | 1.19 |
| Ex. 2 | 1.50 | 67 | 1.2 |
| Ex. 3 | 2.5 | 27 | 1.37 |
| Ex. 4 | 5 | 23 | 1.51 |
| Ex. 5 | 10 | 19 | 1.52 |
| Ex. 6 | 15 | 10 | 1.56 |
| Ex. 7 | 30 | 10 | 1.5 |
| T = 850° C. | | | |
| Comp. Ex. 8 | 0 | 319 | 1.81 |
| Ex. 9 | 2.5 | 128 | 2.04 |
| T = 975° C. | | | |
| Comp. Ex. 10 | 0 | 81 | 0.89 |
| Ex. 11 | 2.5 | 16 | 1.02 |

TABLE 2

| | H₂O content in | Sulfur | |
|---|---|---|---|
| | calcination air, | content, | BET surface |
| | Vol. % | ppm | area, m²/g |
| Raw, un-treated iron oxide | — | 2200 | 7.4 |
| T = 930° C. | | | |
| Comp. Ex. 12 | 0 | 290 | 3.3 |
| Ex. 13 | 10 | 240 | 3.5 |

The examples and comparative example 1 to 15 illustrate the fact that by treating an iron oxide by calcination in the presence of air containing water vapor yields a significantly lower residual halogen or sulfur content than in the original material or in a material treated at the same temperature with dry air. At the same time, the sintering of the iron oxide in the presence of moist air is reduced as compared to the calcination in dry air and the resulted product has a higher surface area and is therefore more suitable for the manufacturing of catalysts, where surface area is favorable for a higher activity. Moreover, the calcination in moist air allows reducing the calcination temperature and by this results in savings of electric energy or fuel gas. For instance, calcination in moist air of a chlorine containing iron oxide yields at 850° C. a lower residual chlorine (128 ppm) and higher surface area (2.04 m²/g) as compared with a material calcined in dry air at 930° C. (147 ppm chlorine and 1.19 m²/g, respectively).

Thus, the method according to the present invention allows for a more economical and efficient treatment of halogen or sulfur contaminated iron oxide materials, which yields high purity materials suitable for different applications like catalysts, batteries, electrotechnical parts etc.

1.-20. (canceled)

21. A method for the refining of a material comprising iron oxide and at least one contaminant selected from the group consisting of halogen and sulfur by reducing the content of the at least one contaminant, characterized by calcining the material in the presence of a gas containing water vapor, wherein the gas is air, nitrogen, combustion gas or a mixture thereof; or a mixture of air and fuel and wherein the gas is free of halogen and wherein the iron oxide comprised in the material consists essentially of hematite in that the iron oxide has a content of the hematite phase of at least 90%.

22. The method of claim 21, wherein the material comprises iron oxide in the amount of at least 90 wt.-%.

23. The method of claim 21, wherein the material comprises chlorine as halogen contaminant, preferably in the amount of at least 800 ppm.

24. The method of claim 21, wherein the material comprises sulfur contaminant, preferably in the amount of at least 800 ppm.

25. The method of claim 21, wherein the calcining is carried out at a temperature ranging from 700° C. to 1200° C.

26. The method of claim 21, wherein the calcining is carried out at a temperature ranging from 850° C. to 1000° C.

27. The method of claim 21, wherein the gas is a mixture containing air, especially air.

28. The method of claim 27, wherein the gas is a mixture of air and fuel, wherein the mixture has an air-fuel equivalence ratio of above 1.0.

29. The method of claim 21, wherein the water vapor is contained in the gas with an amount of at least 0.5 Vol.-%.

30. The method of claim 21, wherein the water vapor is contained in the gas with an amount of from 1 Vol.-% to 50 Vol.-%.

31. The method of claim 21, wherein the content of the at least one contaminant is reduced by at least 85%.

32. The method of claim 21, wherein the specific surface area according to the BET method of the material is from 1 m²/g to 10 m²/g.

33. The method of claim 21, wherein the ratio of gas to the material ranges from 0.01 Nm³/kg to 100 Nm³/kg.

34. The method of claim 21, wherein the material is produced by spray roasting hydrochloride acid waste liquids generated from steel pickling or by a Penniman process.

35. The method of claim 21, wherein the method is carried out without a preceding treatment with an acid or base.

36. The method of claim 21, wherein the method is carried out in a rotating kiln, preferably having an inner ceramic coating.

37. The method of claim 36, wherein the kiln has an inclination from 0.3° to 5°, preferable from 0.4° to 3° related to the horizontal and/or a rotation speed from 0.4 rpm to 8 rpm, preferable from 0.4 rpm to 5 rpm.

38. The method of claim 21, wherein the iron oxide comprised in the material consists essentially of hematite in that the iron oxide has a content of the hematite phase of at least 95%.
